(19) United States
(12) Patent Application Publication
(10) Pub. No.: US 2005/0046203 A1
(43) Pub. Date: Mar. 3, 2005

(54) Bathroom lock device

(75) Inventor: Lan-Shi Huang, Kaohsiung (TW)

Correspondence Address: BACON & THOMAS, PLLC, 625 SLATERS LANE, FOURTH FLOOR, ALEXANDRIA, VA, 22314, US

(73) Assignee: Taiwan Fu Hsing Industrial Co., Ltd., Kaohsiung Hsien (TW)

(21) Appl. No.: 10/662,279

(22) Filed: Sep. 16, 2003

(30) Foreign Application Priority Data
Aug. 26, 2003 (TW) 92215441

(51) Int. Cl. E05B 3/00

(52) U.S. Cl. 292/348

(57) ABSTRACT

A bathroom lock device includes an inner lock assembly, an outer actuating wheel and a latch unit. The inner lock assembly is consisted of an actuating press rod, an unlocking cam and an inner actuating wheel, which constitutes a press-button mechanism. In locking operation, the actuating press rod is pressed to limit rotation of the outer actuating wheel and to rest in lock stage. In unlocking operation, an inner lever is operated to successively actuate the unlocking cam and the inner actuating wheel for rotation. Thus, the preceding rotation of the unlocking cam can push the actuating press rod to rest in unlock stage, and the following rotation of the inner actuating wheel can drive the latch unit for retraction.

### BACKGROUND OF THE INVENTION

1. Field of the Invention

The present invention is related to a bathroom lock device. More particularly, the present invention is related to the bathroom lock device having a press-button mechanism for an inner lock assembly to simplify the entire structure and locking/unlocking operation.

2. Description of the Related Art

Referring to FIG. 1, U.S. Pat. No. 6,568,231, issued on May 27, 2003 to Huang, titled “LOCK STRUCTURE FOR BATHROOM USE,” discloses a lock structure which includes an inner rose 10, an outer rose 20, an inner lock assembly 30 and an outer lock assembly 40. The inner lock assembly 30 and the outer lock assembly 40 are disposed between the inner rose 10 and the outer rose 20. In locking operation, users located in the bathroom can operate the inner lock assembly 30 to lock a bathroom door (not shown). In next unlocking operation, the users located in the bathroom can turn an inner lever 11 or an inner knob of the inner lock assembly 30 to unlock the bathroom door. When the bathroom door is inadvertently locked by accident, an appropriated tool is used to turn the outer lock assembly 40 to unlock it from the outside of the bathroom.

The inner lock assembly 30 is a rotatable actuating mechanism and includes an inner actuating rod 31, a positioning member 32, an inner control gear 33, an elastic member 34 and an inner actuating wheel 35. The inner actuating rod 31 is extended through an aperture 321 of the positioning member 32 to actuate the inner control gear 33 for rotation. The positioning member 32 is mounted in the inner rose 10, and provided with an unlocking groove 322 and a locking groove 323. The inner control gear 33 has an engaging protrusion 331 facing to the positioning member 32, and a plurality of teeth 332 provided on its outer periphery. The elastic member 34 is elastically abutted against the inner control gear 33 so that the engaging protrusion 331 can be selectively engaged with the unlocking groove 322 or the locking groove 323. The inner actuating wheel 35 is rotated by an inner spindle 12, and provided with a notch 351 and a plurality of teeth 352. The unlocking groove 322 and the locking groove 323 has an axial distance therebetween so as to reciprocate the positioning member 32 between unlock stage and lock stage. Namely, in unlocking operation, the engaging protrusion 331 of the inner control gear 33 is engaged with the unlocking groove 322 of the positioning member 32 so that the teeth 332 of the inner control gear 33 can be disengaged from the notch 351 of the inner actuating wheel 35. Consequently, it allows rotation of the inner spindle 12 and the outer spindle 22 for unlocking operation. In locking operation, the engaging protrusion 331 of the inner control gear 33 is engaged with the locking groove 323 of the positioning member 32 by turning an angular movement of 90 degrees of the inner actuating rod 31 so that the teeth 332 of the inner control gear 33 is engaged with the notch 351 of the inner actuating wheel 35. Consequently, it prevents from rotation of the outer spindle 22. Meanwhile, the inner control gear 33 is confronted with the outer lock assembly 40 for unlock operation from the outside.

However, the entire lock structure is sophisticated although users can turn the inner actuating rod 31 of the inner lock assembly 30 for locking operation and the inner lever 11 for unlocking operation. This results in an increase in the manufacturing cost. Furthermore, by use such a lock structure, users must turn an angular movement of 90 degrees of the inner actuating rod 31 for unlocking operation that is inconvenient to children, old people, handicapped people and maimed people etc. Moreover, the teeth 332, 352 of the inner control gear 33 and the inner actuating wheel 35 are easy to be deformed and destroyed, and the positioning member 32 may be broken along the unlocking groove 322 when it is impacted. This may result in a decrease in the useful life of the lock structure. Hence, there is a need for an improvement of the conventional lock structure.

The present invention intends to provide a bathroom lock device which includes an inner lock assembly. The inner lock assembly simply employs a actuating press rod, an unlocking cam and an inner actuating wheel to constitute a press-button mechanism. In locking operation, pressing the actuating press rod can rapidly change to lock stage. In unlocking operation, pressing an inner lever can operate the unlocking cam to return to unlock stage. Thereby, the bathroom lock of the present invention is simplified, convenient for use, suitable for mass production and long-term use in such a way to mitigate and overcome the above problem.

### SUMMARY OF THE INVENTION

The primary objective of this invention is to provide a bathroom lock device having an inner lock assembly, which employs an actuating press rod, an unlocking cam and an inner actuating wheel to constitute a press-button mechanism. In operation, users can easily press the actuating press rod to lock the bathroom lock device that simplifies the entire structure and convenient for operation.

The bathroom lock device in accordance with the present invention includes an inner lock assembly, an outer actuating wheel and a latch unit. The inner lock assembly is consisted of an actuating press rod, an unlocking cam and an inner actuating wheel, which constitutes a press-button mechanism. In locking operation, the actuating press rod is pressed to limit rotation of the outer actuating wheel and to rest in lock stage. In unlocking operation, an inner lever is operated to successively actuate the unlocking cam and the inner actuating wheel for rotation. Thus, the preceding rotation of the unlocking cam can press the actuating press rod to rest in unlock stage, and the following rotation of the inner actuating wheel can drive the latch unit for retraction.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings herein:

FIG. 1 is an exploded perspective view of a lock structure for bathroom use in accordance with the prior art;

FIG. 2 is an exploded perspective view of a bathroom lock device in accordance with a preferred embodiment of the present invention;

FIG. 3 is a cross-sectional view of the bathroom lock device in accordance with the preferred embodiment of the present invention;

FIG. 4 is a cross-sectional view, taken along line A-A in FIG. 3, of the bathroom lock device in accordance with the preferred embodiment of the present invention;

FIG. 5 is a cross-sectional view, similar to that of FIG. 4, of the bathroom lock device in unlocking operation in accordance with the preferred embodiment of the present invention;

FIG. 6 is a cross-sectional view, similar to that of FIG. 3, of the bathroom lock device in unlocking operation in accordance with the preferred embodiment of the present invention; and

FIG. 7 is a cross-sectional view, similar to that of FIG. 4, of the bathroom lock device driving a latch unit in unlocking operation in accordance with the preferred embodiment of the present invention.

### DETAILED DESCRIPTION OF THE INVENTION

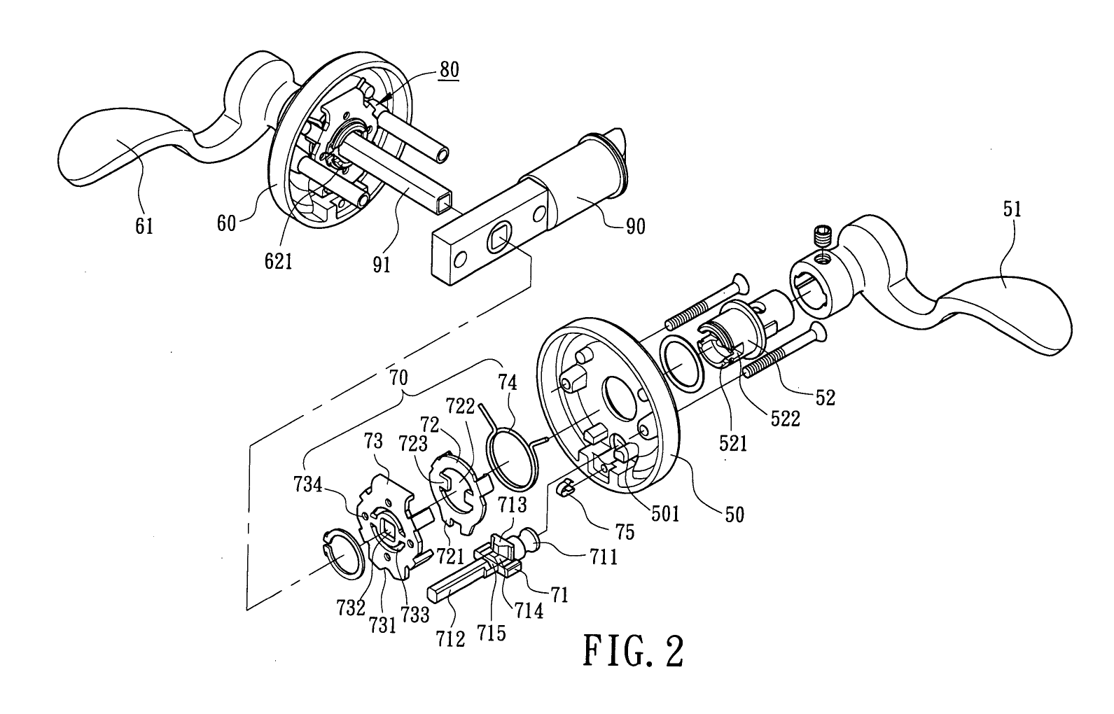

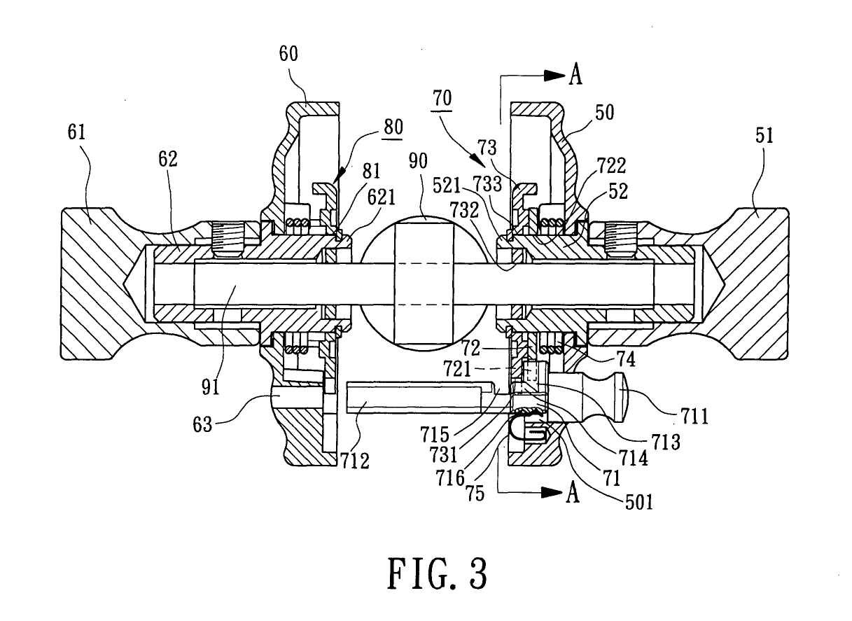

Referring initially to FIGS. 2 and 3, a bathroom lock device in accordance with the present invention includes an inner rose 50, an outer rose 60, an inner lock assembly 70, an outer actuating wheel 80, a latch unit 90 and a spindle 91. The inner rose 50 has an axial hole through which to extend an inner shaft 52. The inner shaft 52 has a first end connected to an inner lever 51, and a second end formed with a pair of assembling walls 521 and a pair of slots 522 defined therebetween. The outer rose 60 has an axial hole through which to extend an outer shaft 62. The outer shaft 62 has a first end connected to an outer lever 61, and a second end formed with a pair of assembling walls 621. Furthermore, the outer rose 60 is formed with an aperture 63. The inner lock assembly 70 is consisted of an actuating press rod 71, an unlocking cam 72, an inner actuating wheel 73, an elastic member 74 and a clip member 75, which constitutes a press-button mechanism for shifting between lock stage and unlock stage. The detailed construction of the inner lock assembly 70 will further be described below.

The outer actuating wheel 80 has a pair of curved holes 81. Each of the curved holes 81 is adapted to receive the corresponding assembling wall 621 of the outer shaft 62. The latch unit 90 allows extension of the spindle 91 and thus a rotational movement of the spindle 91 is able to retract or extend a latch bolt (not shown) of the latch unit 90 so as to situate in unlock stage or lock stage.

Construction of the inner lock assembly 70 shall be described in more detail, referring again to FIGS. 2 and 3. The actuating press rod 71 is provided with a press button 711, a connecting shank 712, an unlocking block 713, a locking block 714, a releasing groove 715, and at least two positioning recessions 716. The press button 711 is mounted on an aperture 501 of the inner rose 50 for allowing users' press operation. The connecting shank 712 is aligned with the aperture 63 of the outer rose 60 when assembled. The aperture 63 allows an appropriated tool to extend through it for actuating the connecting shank 712 for unlocking operation when the inner lock assembly 70 is inadvertently locked by accident. The unlocking block 713 is an upright block having a pair of inclined surfaces and the locking block 714 is a longitudinal block having a pair of inclined surfaces. The releasing groove 715 is located on the connecting shank 712 proximate the locking block 714. The positioning recessions 716 are located at an underside of the actuating press rod 71. The unlocking cam 72 has a pair of lugs 721, an opening 722 and a pair of engaging teeth 723. In operation, the lugs 721 are pushing the inclined surfaces of the unlocking block 713 so that rotation of the lugs 721 results in a longitudinal movement of the actuating press rod 71 to the inner lever 51. The opening 722 and the engaging teeth 723 are securely connected with the assembling walls 521 and the slots 522 to form a tightly assembled relationship so that the unlocking cam 72 and the inner shaft 52 are operated in synchronous movement. The inner actuating wheel 73 has a notch 731, a non-circular hole 732, a pair of curved holes 733 and a plurality of protrusions 734. In lock stage, the notch 731 is engaged with the locking block 714 of the actuating press rod 71 which limits rotation of the inner actuating wheel 73. The non-circular hole 732 is combined with the spindle 91 so that the inner actuating wheel 73 and the spindle 91 have an assembled relationship. The curved holes 733 are loose-fitted with the assembling wall 521 of the inner shaft 52 to form a loose-assembled relationship. Each of the curved holes 733 has an arc length greater than that of the assembling wall 521 so as to allow a predetermined angular movement of the assembling wall 521 within the curved holes 733. In rotational operation, each of the assembling walls 521 is initially confronted with an end of each of the curved hole 733 and thus driven the inner actuating wheel 73 for rotation. Preferably, a series of the protrusions 734 are equi-spaced at one side and contacted with the unlocking cam 72 to thereby maintain a distance therebetween. Consequently, correct alignment of the inner actuating wheel 73 and the unlocking cam 72 with the locking block 714 and the unlocking block 713 is insured.

Preferably, the elastic member 74 has an ordinary form of a spring, such as a coil spring, and is forcibly returning rotation of the unlocking cam 72 and the inner actuating wheel 73.

The clip member 75 is mounted in the inner rose 50 and fixed on one of the positioning recessions 716 of the actuating press rod 71 to ensure it located at a locking position or an unlocking position.

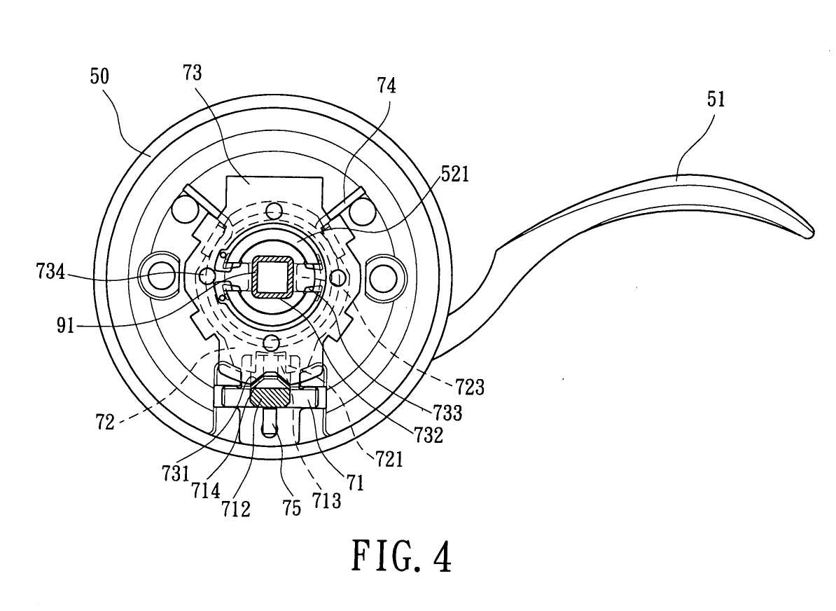

Turning now to FIGS. 3 and 4, the drawings illustrate the bathroom lock device, which is situated in lock stage, in accordance with the present invention. Users located in the bathroom can press the press button 711 of the actuating press rod 71 to move a predetermined longitudinal distance to the outer lever 61. This results in an engagement of the locking block 714 of the actuating press rod 71 with the notch 731 of the inner actuating wheel 73. Thereby, the actuating press rod 71 limits all rotations of the inner actuating wheel 73, the spindle 91, the latch unit 90, the outer actuating wheel 80 and the outer lever 61 for locking purpose, as shown in FIG. 3. An operator located at the outside of the bathroom cannot rotate the outer lever 61 since the assembled relationship of the outer shaft 62, the spindle 91 and the inner actuating wheel 73 which is limited by the locking block 714 of the actuating press rod 71. Under these conditions, such as an irrotational movement of the spindle 91, the latch unit 90 is situated in lock stage.

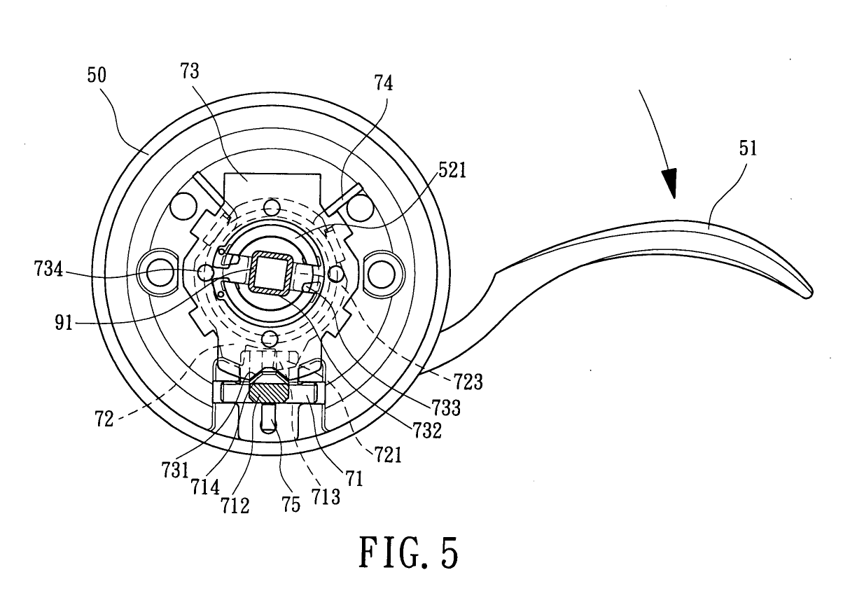

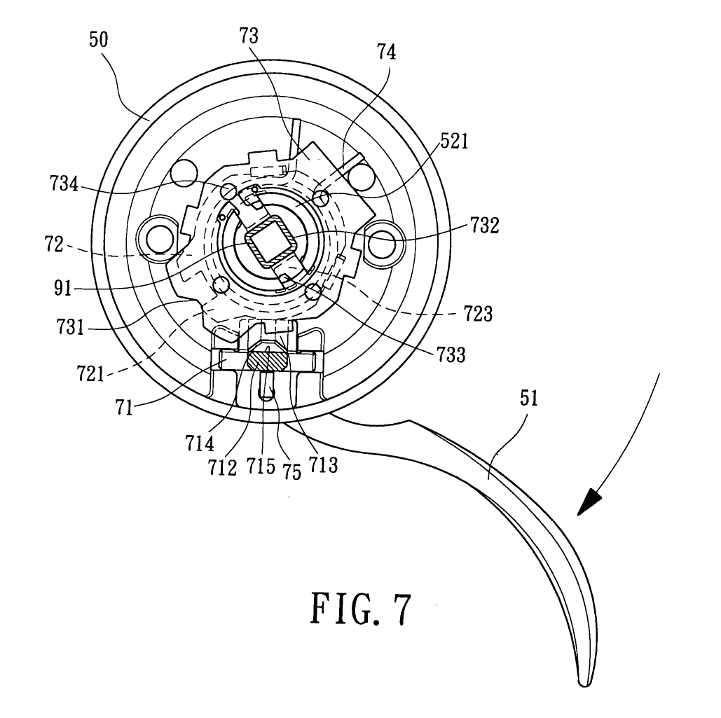

Turning now to FIGS. 5 through 7, the drawings illustrate the bathroom lock device, which is situated in unlock stage, in accordance with the present invention. In unlocking operation, in addition to extract the actuating press rod 71, users located in the bathroom can rotate the inner lever 51 for returning the actuating press rod 71 from the lock stage to the unlock stage.

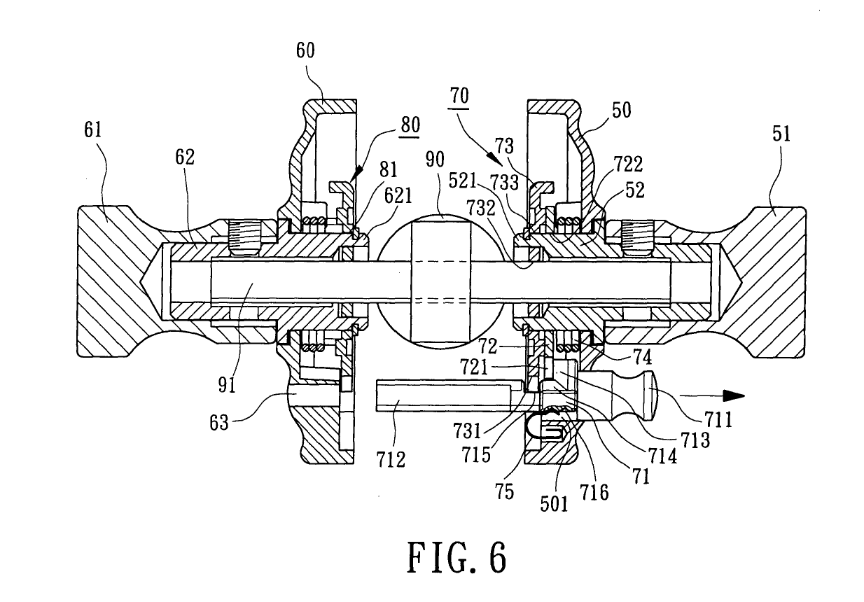

Referring again to FIG. 5, when the rotation of the inner lever 51 drives the inner shaft 52, the assembling wall 521 of the inner shaft 52 firstly actuates the unlocking cam 72 for rotation. Due to the loose-assembled relationship, the rotation of the assembling wall 521 of the inner shaft 52 can still not actuate the inner actuating wheel 73 unless the a predetermined angular rotation of the unlocking cam 72 has been carried out. At that time, the assembling wall 521 of the inner shaft 52 is still spaced from the end of the curved hole 733 of the inner actuating wheel 73. Consequently, the engagement of the notch 731 of the inner actuating wheel 73 with the locking block 714 of the actuating press rod 71 results in a stationary state of the inner actuating wheel 73. Further turning the inner lever 51, the lug 721 of the unlocking cam 72 pushes the inclined surface of the unlocking block 713 of the actuating press rod so as to forcibly move the actuating press rod 71 backward a longitudinal distance, as shown in FIG. 6.

Once the assembling wall 521 of the inner shaft 52 drives the unlocking cam 72 a predetermined angular movement and returns the actuating press rod 71, it can engage with the end of the curved hole 733 of the inner actuating wheel 73. This causes a disengagement of the notch 731 from the locking block 714 of the actuating press rod 71 and a rotation of the inner actuating wheel 73, together with the rotation of the unlocking cam 72. Since the actuating press rod 71 is returned and the releasing groove 715 of the actuating press rod 71 is aligned with the inner actuating wheel 73, it allows rotation of the inner actuating wheel 73 through the releasing groove 715. Finally, the rotations of the inner actuating wheel 73 and the spindle 91 drive the latch unit 90 to retract the dead bolt for opening the bathroom door.

By use such an inner lock assembly 70, the present invention accomplishes a simplified structure and it is convenient for use to children, old people, handicapped people and maimed people etc.

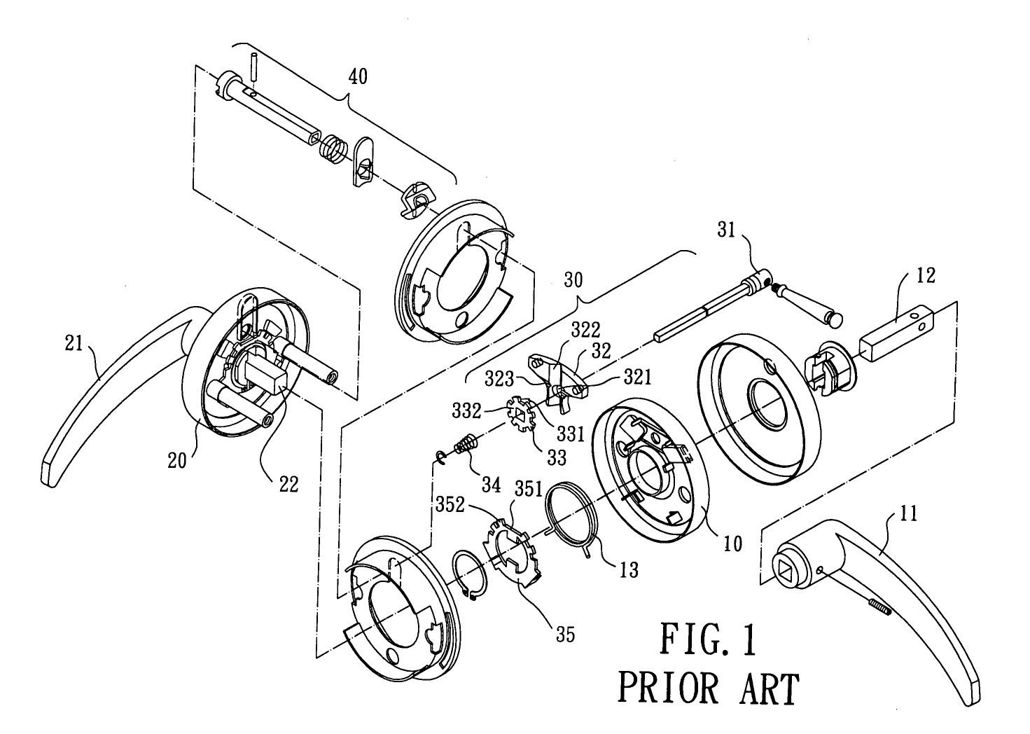

The conventional lock structure, as shown in FIG. 1, has an increase of components, a sophisticated structure, inconvenient use and a weakened structure. In comparison with the conventional lock structure, the bathroom lock device has an inner lock assembly consisted of the actuating press rod 71, the unlocking cam 72 and the inner actuating wheel 73 to constitute a press-button mechanism.

Although the invention has been described in detail with reference to its presently preferred embodiment, it will be understood by one of ordinary skill in the art that various modifications can be made without departing from the spirit and the scope of the invention, as set forth in the appended claims.

1. A bathroom lock device, comprising:
a spindle extended through a latch unit for retracting or extending a dead bolt;
an inner rose having an inner lever;
an inner lock assembly mounted in the inner rose, and consisted of an actuating press rod, an unlocking cam and an inner actuating wheel which constitute a press-button mechanism, the unlocking cam connected with the inner lever having a tightly assembled relationship, the inner actuating wheel connected with the inner lever having a loose-assembled relationship and driven by the spindle;
an outer rose having an outer lever; and
an outer actuating wheel mounted in the outer rose, and connected with the outer lever;
wherein, in locking operation, the actuating press rod is pressed to move a predetermined longitudinal distance to thereby limit rotations of the spindle, the outer actuating wheel and the outer lever;
wherein, in unlocking operation, the inner lever is turned to rotate the unlocking cam and the inner actuating wheel successively, a preceding rotation of the unlocking cam can return the actuating press rod to situate in unlock stage and a following rotation of the inner actuating wheel to actuate the latch unit for retracting a dead bolt.

2. The bathroom lock device as defined in claim 1, wherein the actuating press rod includes an unlocking block and the unlocking cam includes at least one lug engaged with the unlocking block in lock stage; in unlocking operation, rotation of the inner lever results in a longitudinal movement of the actuating press rod to return to an unlocking position.

3. The bathroom lock device as defined in claim 1, wherein the actuating press rod includes a locking block and the inner actuating wheel includes a notch engaged with the locking block in lock stage, thereby limiting the rotations of the spindle, the outer actuating wheel and the outer lever.

4. The bathroom lock device as defined in claim 1, wherein the actuating press rod includes a releasing groove through which to allow rotation of the inner actuating wheel in unlock stage so that rotations of the spindle and the latch unit are allowed.

5. The bathroom lock device as defined in claim 1, wherein the actuating press rod includes a connecting shank and the outer rose includes an aperture aligned with the connecting shank when assembled; the aperture allows an appropriated tool to extend through it for actuating the connecting shank for unlocking operation when the inner lock assembly is inadvertently locked.

6. The bathroom lock device as defined in claim 5, wherein the actuating press rod includes a press button at its end.

7. The bathroom lock device as defined in claim 1, wherein the actuating press rod includes at least two positioning recessions selectively combined with a clip member, the clip member is mounted in the inner rose and fixed on one of the positioning recessions to ensure the actuating rod located at a locking position or an unlocking position.

8. The bathroom lock device as defined in claim 1, wherein the inner lever connected to a first end of the inner shaft, the inner shaft further has a second end formed with a pair of assembling walls and a pair of slots defined therebetween.

9. The bathroom lock device as defined in claim 8, wherein the unlocking cam includes an opening and a pair of engaging teeth which are securely connected with the assembling walls and the slots of the inner shaft to form a tightly assembled relationship.

10. The bathroom lock device as defined in claim 8, wherein the inner actuating wheel includes a pair of curved holes which are loose-fitted with the assembling walls of the inner shaft to form a loose-assembled relationship that allows an angular movement of the assembling wheels within the curved holes.
